(19) United States
(12) Patent Application Publication
(10) Pub. No.: US 2014/0231524 A1
(43) Pub. Date: Aug. 21, 2014

(54) BARCODE SCANNER HAVING LASER ALIGNMENT INDICATION

(71) Applicant: Kenneth Liou, New Taipei (TW)

(72) Inventor: Kenneth Liou, New Taipei (TW)

(21) Appl. No.: 13/768,936

(22) Filed: Feb. 15, 2013

(51) Int. Cl. G06K 7/14

(52) U.S. Cl. CPC G06K 7/14
USPC 235/462.21

(57) ABSTRACT

A barcode scanner having a laser alignment indication mainly has an alignment light source module and a reading light source module. After the alignment light source module is aligned with a barcode, the reading light source module is started to read barcode information. After irradiating the alignment light source module on a luminance parameter adjusting barcode set, a user can further adjust light source intensity of the alignment light source module, thereby solving a defect that an existing laser indication barcode scanner is incapable of adjusting luminance of the laser indication light. Moreover, the laser light source in the present invention uses Class I lasers meeting safety specifications, so that the present invention meets user requirements and is safe.

### BACKGROUND OF THE INVENTION

1. Field of Invention

The present invention relates to a barcode scanner having a laser alignment indication, applied to reading barcode data, and in particular, to a barcode scanner capable of adjusting, through scanning a luminance parameter adjusting barcode set, luminance of a linear alignment laser beam used for positioning.

2. Related Art

When a conventional barcode reader captures barcode information, the barcode reader needs to be accurately aligned with a barcode to be read, so that a detection light source is completely projected to the barcode, thereby capturing the complete barcode information. Hence, an existing barcode reader is further configured with an alignment light source. Currently, some commercial products use intensive laser light as the alignment light source. The light intensity of the laser light should be controlled within a safe usage range, however, in practical usage; the light intensity is often excessive or insufficient. This type of barcode reader is usually used for commodity checking in a large-scale logistics center, as the logistics center uses multi-layer shelves; during tallying, the inventory personnel usually need to read barcodes with a barcode reader from a further distance (for example, a barcode at the higher shelves). In this case, the alignment light source is indispensable. However, in a small-sized warehouse, the inventory personnel read barcodes with a barcode reader from a closer distance. Requirements for the light source intensity are different in the above two cases. Moreover, human eyes have different sensitivities to light, even under the alignment light sources of the same light intensity, different people have different feelings during the operation. However, in a current barcode reader configured with an alignment light source, the light intensity of the alignment light source thereof is set to a fixed value before delivery. Besides, for the sake of operation safety, manufacturers of barcode scanners hardly allow operators to adjust the light intensity of the alignment light sources as wish (especially the intensity of laser light). Therefore, it is an important technical issue to solve this problem.

### SUMMARY OF THE INVENTION

In view of the above problem, the present invention is directed to a barcode scanner having a laser alignment indication, which allows a user to adjust the light intensity of an alignment light source within a safe range.

In order to achieve the above objective, the present invention provides a barcode scanner with a laser alignment indication, having an alignment light source module and a reading light source module. The alignment light source module is capable of generating a linear alignment laser beam, so as to determine the relation of alignment with a barcode to be read through the linear alignment laser beam. The present invention allows a user to adjust the luminance of the alignment light source module within a safe range according to the environment, the need, the sensitivity to light of user eyes, and other requirements. A user can use the alignment light source module to scan a luminance parameter adjusting barcode set, driving the reading light source module to read a barcode of the luminance parameter adjusting barcode set, so as to adjust a luminance parameter, the adjustment at least including brightening and dimming. After being read, the barcode of the luminance parameter adjusting barcode set is further decoded by a micro-control processing module, and the luminance parameter of the alignment light source module is adjusted, so that the luminance of light source generated by the alignment light source module meets a requirement of the user. Further, lasers are categorized into four classes depending on hazards thereof to organisms. Laser photoelectric sensors are categorized into Class I and Class II, both being safe laser classes. Class I lasers are safe for organisms. People usually look away from excessively bright light out of disgust, and such a natural reaction protects people from Class II lasers. Generally speaking, human eyes are safe from Class II lasers unless a person stares at a Class II laser for a few minutes. The laser light source in the present invention uses Class I lasers meeting safety specifications, thereby further ensuring the safety of users.

### BRIEF DESCRIPTION OF THE DRAWINGS

FIG. 1 is a schematic view (1) of members of the present invention;

FIG. 2 is a schematic view (2) of members of the present invention;

FIG. 3 is a schematic view of an actuation process of the present invention;

FIG. 4 is a schematic view (1) of implementation of the present invention;

FIG. 5 is a schematic view (2) of implementation of the present invention;

FIG. 6 shows another embodiment (1) of the present invention; and

FIG. 7 shows another embodiment (2) of the present invention.

### DETAILED DESCRIPTION OF THE INVENTION

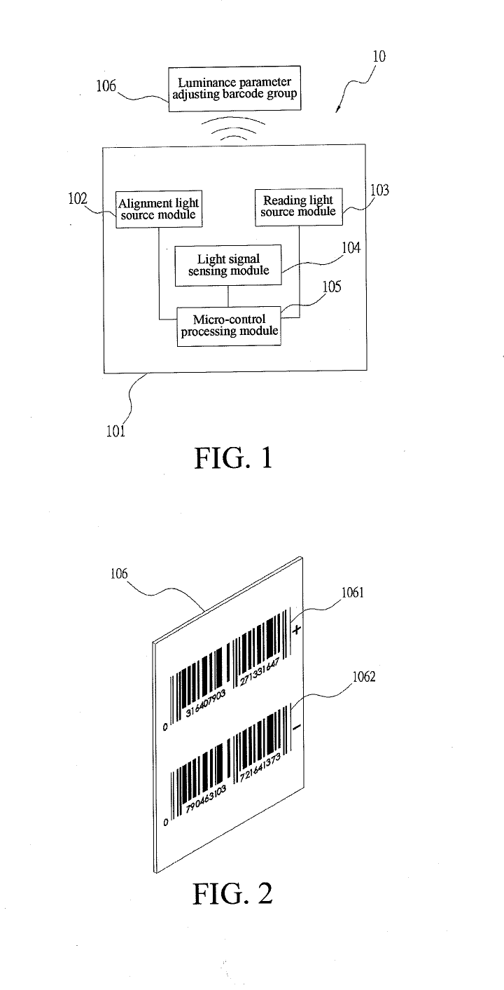

Referring to FIG. 1, FIG. 1 is a schematic view (1) of members of the present invention. A barcode scanner 10 having a laser alignment indication of the present invention mainly has an electrical carrier board 101, an alignment light source module 102, a reading light source module 103, a light signal sensing module 104, a micro-control processing module 105, and a luminance parameter adjusting barcode set 106. An electrical circuit is laid on the electrical carrier board 101, and is electrically connected to related electrical components respectively. The above members are respectively laid on the electrical carrier board 101. The micro-control processing module 105 is electrically connected to the alignment light source module 102, the reading light source module 103, and the light signal sensing module 104 respectively. Further, the reading light source module 103 is mainly formed of one or more light emitting diodes, and may have a function of switching among multiple wavelengths (multiple colors). When actuated, the reading light source module 103 may be coordinated with an existing external light source, or one of the light emitting diodes may supplement the light source if the light source is insufficient. After the micro-control processing module 105 actuates the alignment light source module 102, the alignment light source module 102 may generate a linear alignment laser beam irradiating a barcode, and further generate an alignment confirmation signal. After the alignment confirmation signal is received by the light signal sensing module 104, the reading light source module 103 is actuated and irradiates the barcode, so as to further generate a barcode information reflection signal. The barcode information reflection signal is then transferred to the micro-control processing module 105 through the light signal sensing module 104, so that the micro-control processing module 105 interprets and decodes the barcode information.

Referring to FIG. 2, FIG. 2 is a schematic view (2) of members of the present invention. With reference to FIG. 1, a luminance parameter adjusting barcode set 106 shown in FIG. 2 is a card, on a surface of which more than one group of barcode information to be read by a scanner are printed. The barcode information printed on the luminance parameter adjusting barcode set 106 of the present invention is mainly a luminance increasing barcode 1061 and a luminance decreasing barcode 1062. The luminance increasing barcode 1061 and the luminance decreasing barcode 1062 are each a parameter control instruction. For example, when the scanner scans the luminance increasing barcode 1061, the micro-control processing module 105 of the scanner uses current light source luminance of the alignment light source module 102 as a reference value, and increases the current light source luminance by one scale, so as to increase the light source luminance of the alignment light source module 102. On the contrary, if the luminance decreasing barcode 1062 is irradiated, the micro-control processing module 105 uses the current light source luminance of the alignment light source module 102 as a reference value, and decreases the current light source luminance by one scale, so as to reduce the light source luminance of the alignment light source module 102. A manner for reading information of the luminance increasing barcode 1061 and luminance decreasing barcode 1062 is the same as that described in FIG. 1. Moreover, a luminance interval of the luminance parameter adjusting barcode set 106 is set before delivery, and is within the safe range. Even if the user reads the luminance increasing barcode 1061 repeatedly, the luminance is merely increased to an upper limit of the safe range, thereby improving the use safety.

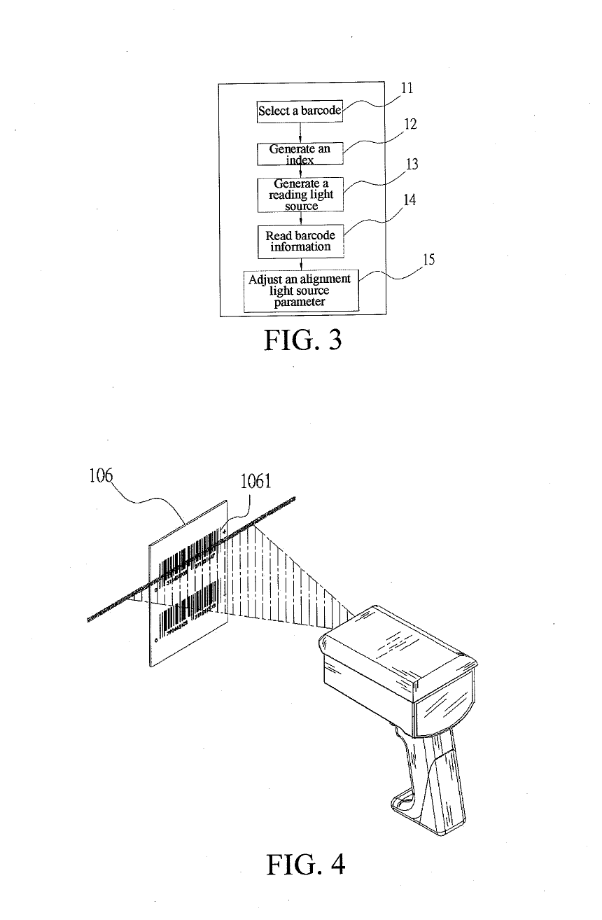

Referring to FIG. 3, FIG. 3 is a schematic view of an actuation process of the present invention. Generally, when a user uses the barcode scanner, the first action is to actuate the barcode scanner (which is similar to a pre-scanning action). Upon started, the barcode scanner 10 having a laser alignment indication of the present invention first generates an alignment light source (namely, a laser light source); alternatively, upon started, the barcode scanner 10 having a laser alignment indication first generates an alignment light source (laser light source), and then generates a reading light source (for example, green light) after alignment. If no position or barcode is obtained through interpretation, the foregoing process is repeated until a position or a barcode can be read. For example, in reading of a color barcode, if an original reading light source fails to read the color barcode due to chromatic aberration, a light source of another color (wavelength) is used for reading, for example, an orange light source is used for reading. Further referring to FIG. 1 and FIG. 2, the actuation process of the present invention is described as follows:

(1) Select a barcode 11: a user determines whether current light source intensity of an alignment light source module 102 is sufficient according to a current use environment, condition or a own requirement, and further selects to scan a luminance increasing barcode 1061 or a luminance decreasing barcode 1062.

(2) Generate an index 12: after the user selects to scan the luminance increasing barcode 1061 or the luminance decreasing barcode 1062, the user further aligns the scanner with the barcode to be scanned and starts the scanner, so that the alignment light source module 102 generates a linear alignment laser beam and projects the linear alignment laser beam to the barcode to perform alignment confirmation on a scanning position.

(3) Generate a reading light source 13: after. the alignment confirmation, a micro-control processing module 105 further stops the alignment light source module 102, and meanwhile the micro-control processing module 105 actuates the reading light source module 103; after the reading light source module 103 is actuated, a reading light source generated by the reading light source module 103 is completely projected to the barcode.

(4) Read barcode information 14: when the reading light source is projected to the barcode, a barcode reflection light source (barcode information reflection signal) is generated due to different light reflectance of a black bar and blank, and the barcode reflection light source is then projected to the light signal sensing module 104, so that after photoelectric conversion, information recorded on the barcode is obtained.

(5) Adjust an alignment light source parameter 15: after a light signal sensing module 104 receives the barcode information reflection signal, the light source intensity of the alignment light source module is adjusted through the micro-control processing module 105.

Referring to FIG. 4, FIG. 4 is a schematic view (1) of implementation of the present invention. The present invention allows a user to use a scanner to read a parameter control instruction on a barcode, so as to adjust light source luminance of a linear alignment laser beam. As shown in FIG. 4, the user may increase the light source luminance of the linear alignment laser beam through scanning a luminance increasing barcode 1061 in a luminance parameter adjusting barcode set 106.

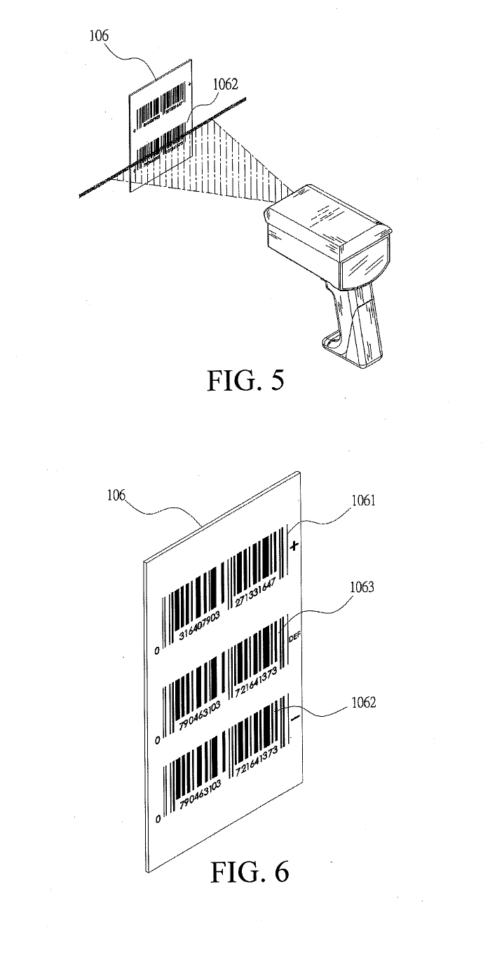

Further referring to FIG. 5, FIG. 5 is a schematic view (2) of implementation of the present invention. On the basis of FIG. 4, the light source luminance of the linear alignment laser beam may also be decreased through scanning a luminance decreasing barcode 1062 in the luminance parameter adjusting barcode set 106. Hence, users can adjust the light source luminance of the linear alignment laser beam on their own. Moreover, the laser light source in the present invention uses Class I lasers meeting safety specifications, thereby further ensuring the safety of users.

Referring to FIG. 6, FIG. 6 shows another embodiment (1) of the present invention. In order to further facilitate the user to adjust the light source luminance, a luminance reset barcode 1063 is added to the luminance parameter adjusting barcode set 106. The luminance reset barcode 1063 is mainly used for resetting the light source luminance of the linear alignment laser beam to an initial luminance setting state (namely, the original parameter set before delivery) after the user reads the light source luminance through the scanner, so that the user can re-adjust the light source intensity of the linear alignment laser beam.

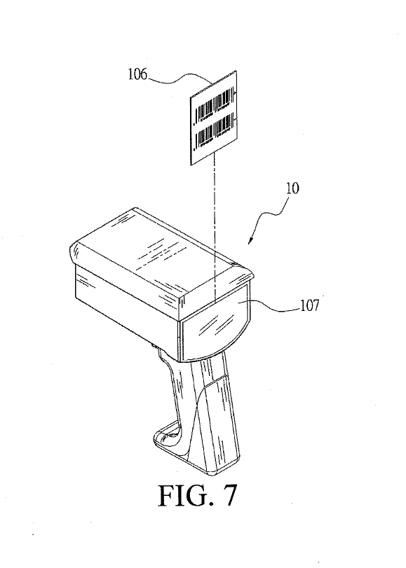

Referring to FIG. 7, FIG. 7 shows another embodiment (2) of the present invention. In order to improve use convenience for users, in the present invention, a placement portion 107 is further disposed outside the barcode scanner 10 having a laser alignment indication, and the placement portion 107 may be a bag. Hence, it is more convenient for a user to use or store the luminance parameter adjusting barcode set 106.

To sum up, the barcode scanner having a laser alignment indication in the present invention can adjust the light source luminance of the alignment light source module through reading parameter control instructions in the luminance parameter adjusting barcode set, so that the user can adjust the light source intensity of a linear alignment laser beam generated by the alignment light source module at any time according to a requirement. Moreover, the laser light source in the present invention uses Class I lasers meeting safety specifications, thereby further ensuring the safety of users. Besides, to meet an energy-saving requirement, in the present invention, when the reading light source module is actuated, the alignment light source module can be automatically turned off. Therefore, the implementation of the present invention achieves the objective of providing a barcode scanner having a laser alignment indication that allows a user to adjust the light intensity of the alignment light source within a safe range.

The exemplary embodiments of the present invention are described above, which are not intended to limit the implementation scope of the present invention. All equivalent alteration and modification made by persons skilled in the art without departing from the spirit and scope of the present invention shall fall within the scope of the claims of the present invention.

What is claimed is:

1. A barcode scanner having a laser alignment indication, comprising:
an electrical carrier board, an electrical circuit being laid on the electrical carrier board;
an alignment light source module, electrically assembled on the electrical carrier board, and used for generating a linear alignment laser beam;
a reading light source module, electrically assembled on the electrical carrier board, and used for generating a reading light source;
a light signal sensing module, electrically assembled on the electrical carrier board, and used for receiving an alignment confirmation signal and a barcode information reflection signal that are generated by the alignment light source module and the reading light source module after the alignment light source module and the reading light source module irradiating a barcode;
a micro-processing controller, electrically assembled on the electrical carrier board, and electrically connected to the alignment light source module, the reading light source module, and the light signal sensing module respectively; and
a luminance parameter adjusting barcode set, having a luminance increasing barcode and a luminance decreasing barcode to be read by the reading light source module, so that light source intensity of the alignment light source module is relatively increased or decreased.

2. The barcode scanner having a laser alignment indication according to claim 1, having a placement portion disposed outside for receiving the luminance parameter adjusting barcode set.

3. The barcode scanner having a laser alignment indication according to claim 1, wherein the luminance parameter adjusting barcode set has a luminance reset barcode.

4. The barcode scanner having a laser alignment indication according to claim 1, wherein the reading light source module has a function of switching a light source among multiple wavelengths.

5. The barcode scanner having a laser alignment indication according to claim 1, wherein when the reading light source module is actuated, the alignment light source module is capable of being automatically turned off.

6. A method for adjusting light source intensity of a barcode scanner having a laser alignment indication, comprising:
a step of selecting a barcode: selecting a barcode from a luminance parameter adjusting barcode set;
a step of generating an index: starting the barcode scanner having a laser alignment indication and aligning the barcode scanner having a laser alignment indication with the barcode to be scanned, so that a linear alignment laser beam generated by an alignment light source module performs alignment confirmation on the barcode;
a step of generating a reading light source: after the alignment confirmation, a micro-control processing module stopping the alignment light source module, and meanwhile the micro-control processing module actuating a reading light source module, so that a reading light source generated by the reading light source module is projected to the barcode;
a step of reading barcode information: after the reading light source is projected to the barcode, generating a barcode information reflection signal; and
a step of adjusting an alignment light source parameter: after a light signal sensing module receives the barcode information reflection signal, adjusting light source intensity of the alignment light source module through the micro-control processing module.
